(19) United States
(12) Patent Application Publication
(10) Pub. No.: US 2002/0176604 A1
(43) Pub. Date: Nov. 28, 2002

(54) Systems and methods for determining eye glances

(76) Inventors: Chandra Shekhar, College Park, MD (US); Philippe Burlina, North Bethesda, MD (US); Qinfen Zheng, Ellicot City, MD (US); Rama Chellappa, Potomac, MD (US)

Correspondence Address: Chandra Shekhar, Image Corp., Suite 106, 6411 Ivy Lane, Greenbelt, MD, 20770, US

(21) Appl. No.: 09/836,079

(22) Filed: Apr. 16, 2001

(51) Int. Cl. G06K 9/00

(52) U.S. Cl. 382/104; 382/107; 382/117

(57) ABSTRACT

A method determines driver glance information from an input video by performing motion analysis on the video; and performing image analysis on a frame of the video.

The present invention relates to systems and methods for determining eye glances.

Highway transportation is the lifeblood of modem industrial nations. In the U.S., as in many other places, large highways and freeways are sorely overburdened: around major cities, heavy usage slows most peak-hour travel on freeways to around 10-20 miles per hour. Under these conditions, a driver's senses may be fully occupied as a result of the large cognitive load demanded for driving a vehicle under congestion. To operate a vehicle safely, drivers use their hands for steering and manipulating other vehicle user interfaces such as the gearshift, turn signals, windshield wipers, heating mechanism, and parking brake. The driver also must focus attention on the road, on the traffic, and on vehicle operation devices such as rear-view mirrors, speedometer, gas gauge, and tachometer.

Further, driving in traffic is not the only burden on drivers. A plethora of electronic devices such as radios, MP3 players, and cellular phones compete for the driver's attention span. Additionally, computer technology for providing information and application functions to automotive vehicles is becoming pervasive. For example, vehicles are being outfitted with computers that contain display devices, speech synthesis, text-to-speech (TTS) interfaces, and a multitude of input devices such as speech recognizers, remote control devices, keyboards, track balls, joysticks, touch-screens, among others. These and other complex devices place a cognitive burden on the driver and may negatively affect the driver's primary responsibility of driving a vehicle in a safe and responsive manner.

One way to understand the driver's cognitive processing is to analyze the driver's glance. Eye-movement protocols (sequences of recorded eye-glance locations) represent actions at a fine temporal grain size that yield important clues to driver behavior, including what information people use in driving and when they use it; how much time drivers need to process various pieces of driving information; and when people forget and review previously encoded information. Also, humans need little if any instruction or training to produce informative data; in most applications, driver-glance data is collected non-intrusively, such that data collection in no way affects task performance. In addition, driver glance can serve as the sole source of data or as a supplement to other sources like verbal protocols. Thus, while driver glance does not entirely reveal the driver's thoughts, their flexibility and wealth of information make them an excellent data source for many studies and applications.

Although driver glances are extremely flexible and informative, they are also very time-consuming and tedious to analyze. Like verbal protocols, several trials of even a simple task can generate enormous sets of eye-glance data, all of which must be coded into some more manageable form for analysis. For large eye-glance data sets with hundreds or thousands of trial protocols, it is difficult for humans to code the data in a timely, consistent, accurate, and cost-effective manner.

### SUMMARY

In one aspect, a method to process driver glance information from an input video includes performing motion analysis on the video; and performing image analysis on a frame of the video.

Implementations of the aspect may include one or more of the following. The process includes performing temporal analysis. A time-history of motion measurements can be used to determine the driver glance direction. The input video can be segmented into one or more key frames. The motion analysis can use optic flow computation. The motion analysis can use feature point tracking. The single-frame image analysis can use color and intensity information in the image. The single-frame image analysis can localize and characterize the driver's face. The process can gather statistics of driver gazing activity. The driver gazing activity can be summarized with a begin frame, an end frame, nature of the glance, duration of the glance and direction of the glance. The motion analysis can detect head motion measurement from the video. The method includes performing glance recognition from the video. The method can detect qualitative head movements such as “looking left”, “looking right”, “looking up”, “looking down” and “looking straight”. The method can detect and characterize a face from an image of the video. The process can detect facial symmetry. The method can also find eye positions. A motion-based video segmentation as well as key frame detection can be performed. The method can interpret driver head movements from feature point trajectories in the video.

Advantages of the system may include one or more of the following. The system performs human-performance measurement for analyses of cognitive loading, including ergonomic efficiency of control interfaces. The system can perform fatigue and inattention monitoring of drivers and pilots to support real-time face tracking. The system can interpret a user's face and measure his or her intention, or inattention and thus allows the user's face to be used as a natural interface in various applications such as video games, flight simulators, and Website eye-glance analysis. Additionally, when used as an eye-glance protocol analysis, the system allows investigators to analyze larger, more complex data sets in a consistent, detailed manner that would otherwise be possible.

One implemented system can determine the beginning and end of the gazing activity in the video sequence, indexed by the direction and duration of glance. Using advanced machine vision techniques, glance video indexing and analysis tasks are performed automatically, and with enhanced speed and accuracy. The system can condense an hour of video with over 100,000 frames into less than 500 key frames summarizing the beginning and end of the gazing activity and indexed by the nature, duration and direction of glance.

### BRIEF DESCRIPTION OF THE DRAWINGS

FIG. 1 shows an exemplary driver video analysis system.

FIG. 2 shows a flowchart of an exemplary motion analysis unit to analyze video data.

FIG. 3 shows a process to plot the motion profile.

FIG. 4 shows a process to perform video skimming and key frame detection.

FIG. 5 shows a finite state machine to classify the driver's glances into qualitative categories.

FIG. 6 shows a finite state machine for up/down and left/right glances.

FIG. 7 shows an exemplary process to perform single image analysis.

FIG. 8 shows a face detection process.

FIG. 9 shows a face characterization process.

FIG. 10 shows a process for performing image feature tracking.

FIG. 11 shows details of a face pose estimation process based on feature tracking.

### DESCRIPTION

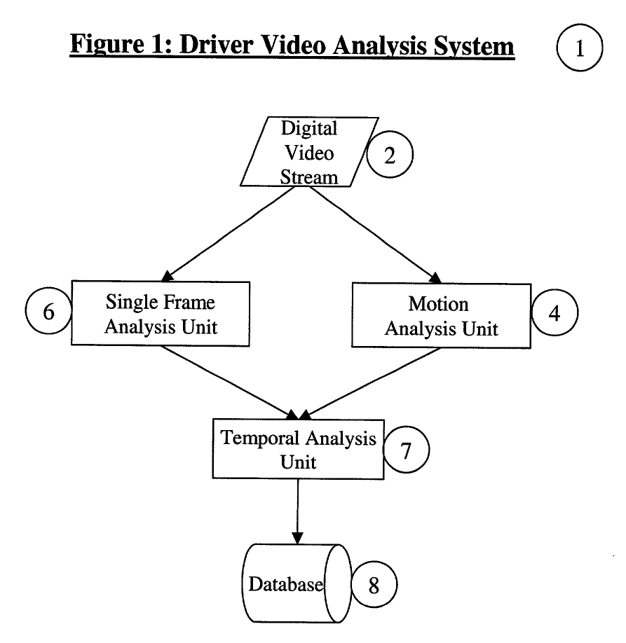

An exemplary driver video analysis system 1 is shown in FIG. 1. A video source 2 such as a digital video stream either from a camera or from previously acquired driver video is provided as input to the system 1. The output of the system 1 is an analysis of driver glance behavior performed in real time. The input video is provided to a motion analysis unit 4 and a single-frame image analysis unit 6. The outputs of the units 4 and 6 are presented to a temporal analysis unit 7, whose output is provided to a database 8.

The units 4 and 6 perform complementary processing on the input data: motion analysis and (single-frame) image analysis. Motion analysis relies on the information that is contained in the driver's movements. Two methods of motion analysis are employed: optic flow computation and feature point tracking. Single-frame analysis, on the other hand, relies on the color and intensity information present in individual images, to detect, localize and characterize the driver's face. Single-frame methods can be used to complement the motion analysis to ensure greater overall reliability. These analyses are followed by temporal analysis, wherein the time-history of motion measurements is used to determine the driver's glance directions, as well as segment the input video into key frames.

In one embodiment, the unit 1 operates in real-time and is mounted in a vehicle with a camera as the video source 2. In a second embodiment, the unit 1 operates in a post-processing mode and runs on a desktop workstation that receives previously recorded video.

The system 1 performs or enables one of more the following:

Head motion measurement from video

Using optic flow techniques

Using feature tracking

Glance recognition

Detecting qualitative head movements like “looking left”, “looking up” etc. as well as glances such as left shoulder, front, rear-vew mirror, etc. using optic flow measurements

Motion-based video segmentation

Determining “interesting” video segments

Extracting “key” frames

Face detection and characterization from single images

Detecting and localizing the driver's face, measuring symmetry, finding eye positions, etc.

The exemplary glance analysis system can be used in an automotive environment to detect driver eye glances. Additionally, the system 1 can be used in a number of other applications, such as advanced video games, flight simulators, virtual reality environments, etc. It could also be used in a Web environment to detect eye glances at one or more commercials.

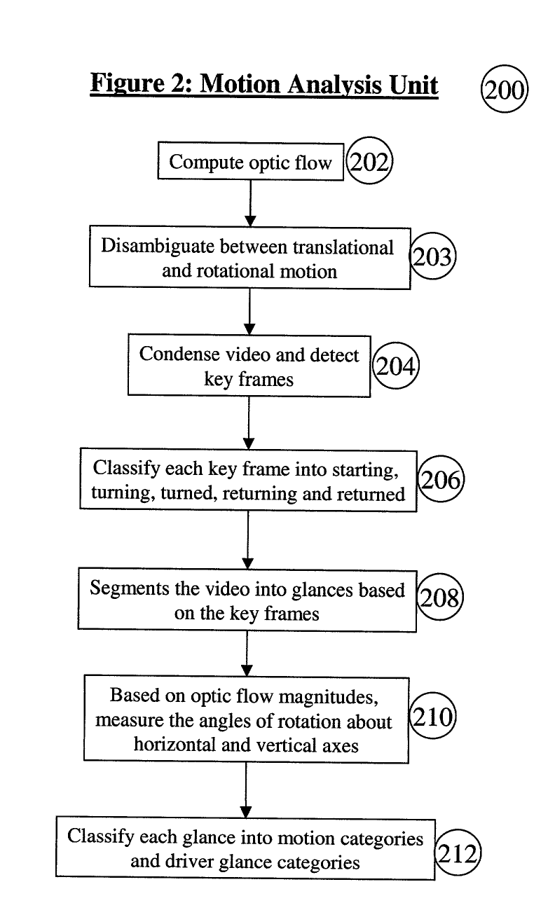

FIG. 2 shows a flowchart 200 of an exemplary motion analysis unit 4 to analyze video data. In the case of driver video, the movements of the driver's head provide important information about his/her glances. The process 200 performs motion analysis and glance recognition first by computing flow computation, such as optic flow (step 202). Optic flow refers to the apparent flow of image intensities in a video sequence. A correlation-based algorithm is used to estimate the optical flow, using the sum of absolute differences (SAD) instead of correlation for efficiency reasons since correlation-based algorithms can be computationally expensive. To improve robustness, optic flow is computed only in areas of the image exhibiting significant inter-frame change, determined by the intersection of two successive frames differences (frames f1and f2 with f2 and f3). The average horizontal and vertical components of the flow are computed, denoted by (u_{k,},vₖ). The average optic flow provides valuable information about the driver's head movements, which in turn are related to his/her glance. Although the optic flow averaged over the entire image is sufficient for many analyses, a fine-grain measure of the motion is done to disambiguate between translational and rotational movements. The average optic flow is now computed inside each grid element.

Based on the mean flows in the grid elements, the process 200 then disambiguates between translational and rotational motion (step 203). Next, the process of FIG. 2 condenses the video and detects key frames (step 204). Based on the mean flows and their derivatives, the process 200 classifies each key frame into the following categories: starting, turning, turned, returning and returned (step 206). The process 200 then segments the video into glances based on the key frames (step 208). Based on the magnitudes of the horizontal components, the process 200 measures the angles of rotation (step 210). Additionally, based on the angles of rotation, the process 200 classifies each glance into (a) motion categories (including left, right, up and down) and (b) driver glance categories (including left shoulder, left mirror, road ahead, radio, center mirror, right mirror, right shoulder) (step 212).

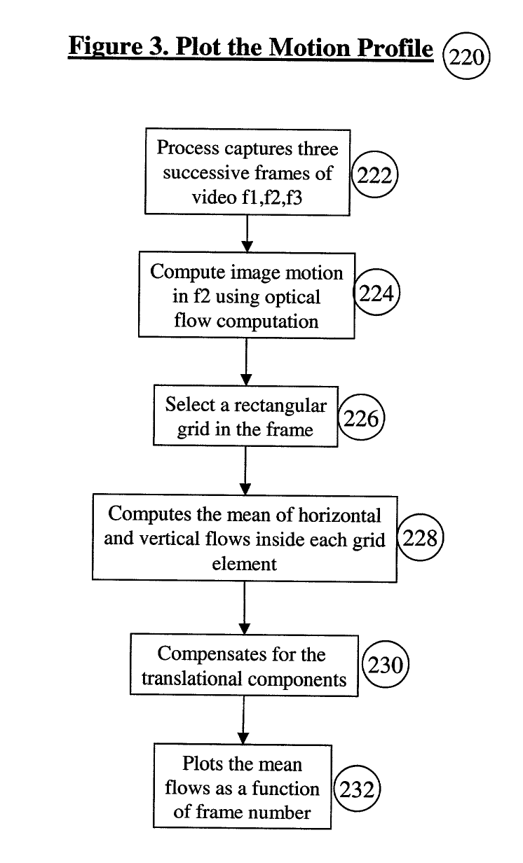

FIG. 3 shows a process 220 to plot the motion profile. First, the process captures three successive frames of video, f1, f2 and f3 (step 222). Next, the process 220 computes the optic flow (apparent image motion) for f2 using the optic flow computation discussed above (step 224). The process 220 then selects a rectangular grid in the frame (step 226) and computes the mean of the horizontal and vertical flows inside each grid element (step 228). To eliminate the translational component of the motion, the mean horizontal flow from the left and right grid elements and the mean vertical component from the upper and lower grid elements are subtracted from the flows (step 230). The process 220 then plots the mean flows as a function of frame number (step 232). The above steps are repeated for each successive frame.

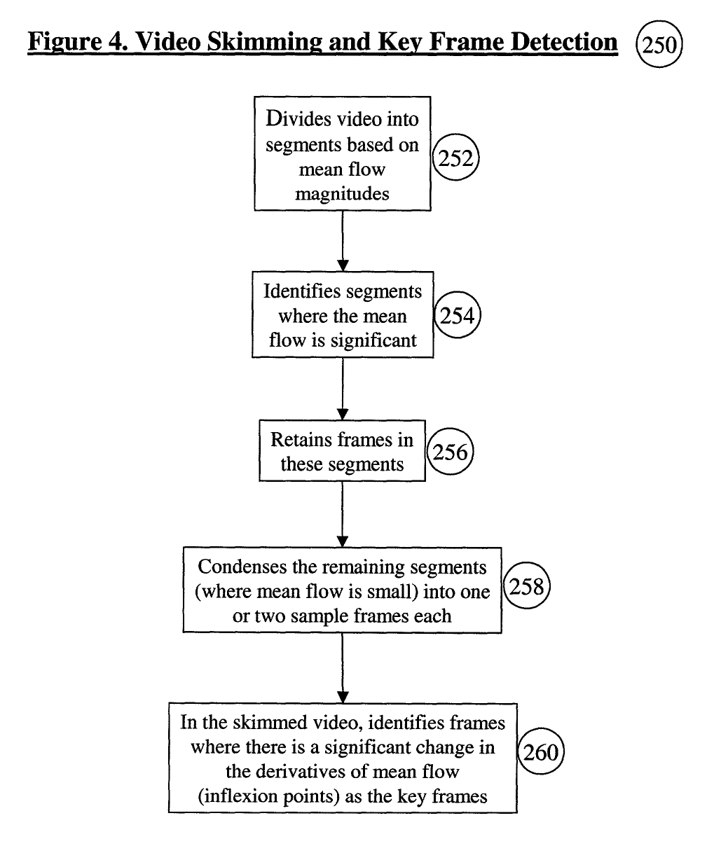

FIG. 4 shows a process 250 to perform video skimming and key frame detection. This process is based in part on the observation that driver glancing activity strongly correlates with optic flow measurements and that driver video can be glance-segmented based on the temporal optic flow profile. The optic flow remains relatively low except when the driver changes his/her glance. Thus one method of extracting “interesting” segments from the video can discard image frames in which the average optic flow is below a threshold, retaining only a single frame for each such segment. This typically results in a 10:1 compression. Further reduction can be achieved by retaining only the key frames corresponding to the inflexion points in the optic flow profile, as explained in more details below.

Referring now to FIG. 4, from the motion profile generated in FIG. 3, the process 250 divides the video into segments based on the mean flow magnitudes (step 252). Next, the process identifies segments where the mean flow is significant (step 254). Frames in these segments are retained (step 256) and the remaining segments (where the mean flow is small) are condensed into one or two sample frames each (step 258). The result is a skimmed video containing only the significant segments. In the skimmed video, the process 250 identifies frames where there is a significant change in the derivatives of the mean flows (inflexion points) as the key frames (step 260). A user can view the key frames and skip the remaining frames.

Pseudo code for the above processes is shown below:

Plotting the motion profile

Capture three successive frames of video, f1, f2 and f3

Compute the optic flow (apparent image motion) for f2

Select a rectangular grid in the frame

Compute the mean of the horizontal and vertical flows inside each grid element

Remove the translational components of the motion

Plot the mean flows as a function of frame number

Repeat above steps for successive frames

Video skimming and key frame detection

From the motion profile, divide the video into segments based on the mean flow magnitudes.

Identify segments where the mean flow is significant.

Retain all the frames in these segments, condense the remaining segments (where the mean flow is small) into one or two sample frames each. The result is a skimmed video containing only the significant segments

In the skimmed video, identify frames where there is a significant change in the derivatives of the mean flows (inflexion points). These are the key frames.

Motion Analysis and Glance Recognition

Based on the mean flows in the grid elements, disambiguate between translational and rotational motion

Based on the mean flows and their derivatives, classify each key frame into the following categories: starting, turning, turned, returning and returned

Segment the video into glances based on the key frames

Based on the magnitudes of the horizontal components, measure the angles of rotation.

Based on the angles of rotation classify each glance into driver glance categories: left shoulder, left mirror, road ahead, radio, center mirror, right mirror, right shoulder.

A glance consists typically of five key frames, denoted by starting, turning, turned, returning, and returned. In the rest states (starting and returned), the optic flow is low, whereas it is relatively high during the turning and returning states, because that is when the driver is moving his head the most rapidly. When the driver has fully turned his head, i.e. in the turned state, the flow is relatively low.

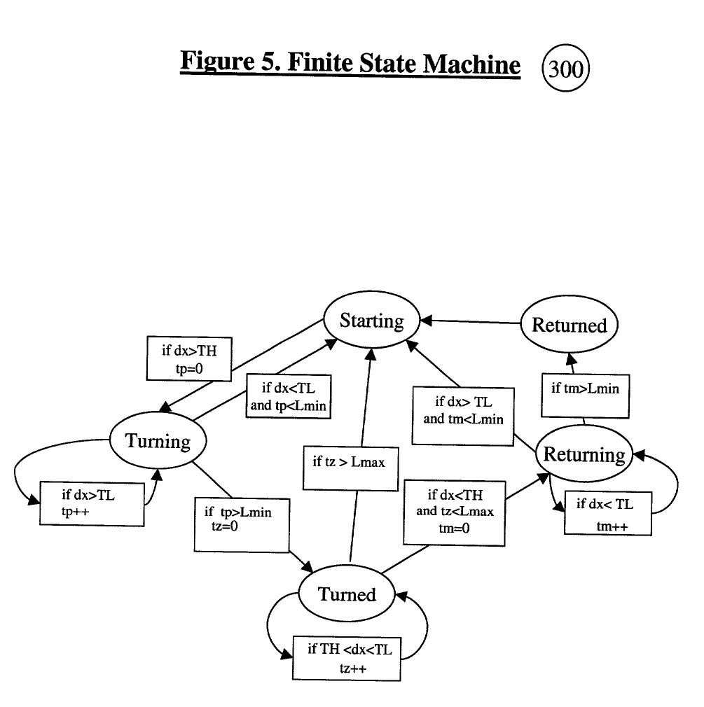

FIG. 5 shows a system to classify the driver's glances into qualitative categories such as looking left, looking right, looking up, looking down, among others. These can be refined to identify the glance zone in vehicle terms (rear-view mirror, over the left shoulder, for example). Using the average optic flow as input, the head movements are modeled using a finite state machine (FSM) 300. The primary input to the FSM 300 is a temporal history of horizontal and vertical average flows (uk,vk). The machine is initially in a rest state (starting), and stays there as long as the flow is below a threshold. If the flow is positive, and exceeds the threshold, it triggers the FSM to the turning state. If it successfully passes through the turned and returning states and reaches the returned state, the glance “looking right” is recognized. The FSM is then re-initialized to the starting state.

The FSM of FIG. 5 represents the glance “look right”. In FIG. 5, dx is the average optic flow in the horizontal direction; TH and TL are upper and lower thresholds on dx. tp, tz and tm are durations measured in number of frames; Lmin and Lmax are minimum and maximum durations in a state. Successful state transitions corresponding to the expected optic flow profile for the glance traverse the FSM. If the glance is not recognized because one or more of the conditions in the FSM are not met, the FSM moves back to the starting state. For instance, if too little time is spent in the turning state, a false alarm is assumed, and the FSM is re-initialized.

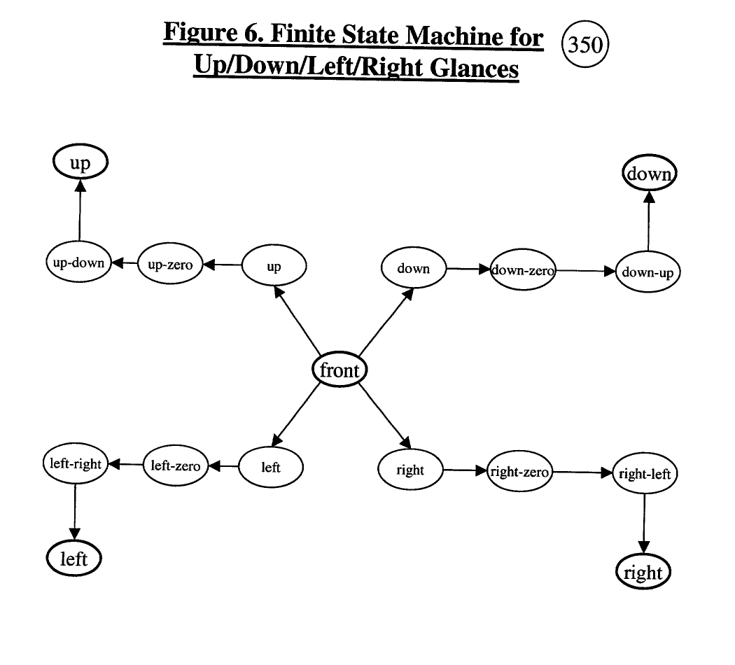

FIG. 6 shows a finite state machine 350 for up/down and left/right glances. The front state corresponds to the starting state. The other four canonical states (turning, turned, returning, returned) are given different names for each type of glance. For instance, in an upward glance, the driver looks up (“up”), stays there for a brief moment (“up-zero”), shifts his glance back down (“up-down”) and looks front again.

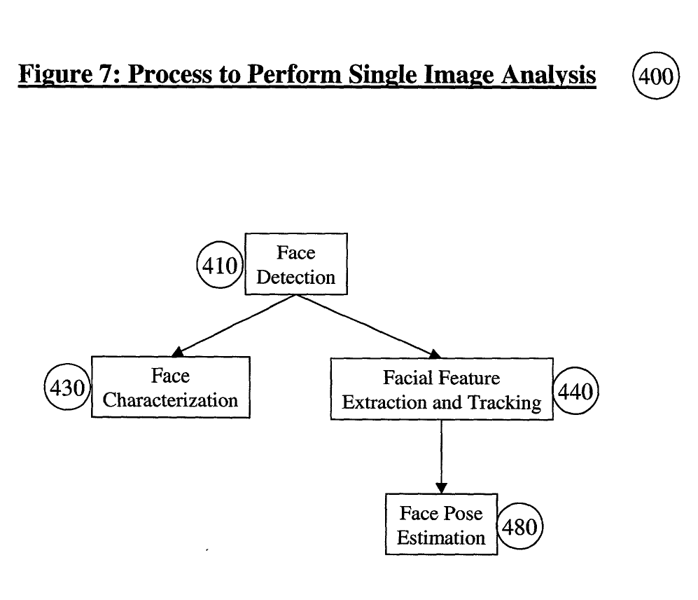

FIG. 7 shows an exemplary process 400 to perform single image analysis. The techniques can extract glance-related information from single images, such as localizing and characterizing the driver's face. Some of these techniques require fairly high-quality color imagery, unlike motion analysis, which can work on low-quality greyscale data. Whereas motion analysis can be used for glance recognition, single image analysis can be used for head pose measurement. The process 400 first performs face detection (step 410). Next, the process 400 characterizes the face (step 430). The process 400 then extract and tracks facial features (step 440), and estimates the face pose based on the positions of these features (step 480).

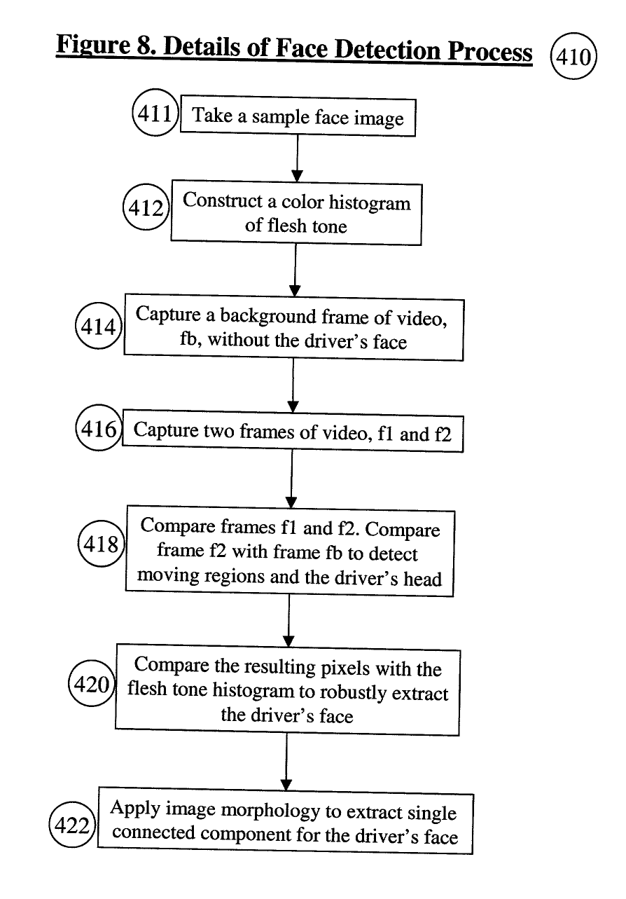

FIG. 8 shows in more detail the face detection process 410. From a sample face image, the process constructs a color histogram of flesh tone (step 412). Next, the process captures a background frame of video, fb, without the driver's face (step 414). Two frames of video, f1 and f2, are then captured (step 416), and frame f2 is compared with f1 and frame f2 is also compared with frame fb to detect moving regions and the driver's head (step 418). Next, the process compares the resulting pixels with the flesh tone histogram to robustly extract the driver's face (step 420). The process then applies image morphology to extract a single connected component for the driver's face (step 422).

Face detection relies on a combination of two visual cues, flesh tone detection and background subtraction, to robustly determine image regions corresponding to the driver's face. The center of mass and the moment of inertia of pixel candidates are used to draw a box around the probable head location. The baseline face detection result is improved using two additional refinements: Chromatic segmentation and robust face localization.

Chromatic segmentation is performed in YUV or HSV space, considering only the chromatic components (i.e. U and V or H and S). An alternative approach is to normalize the RGB measurements by the sum of the intensities in the three color bands, i.e. considering only the normalized color coordinates C(r,g), where

$$r = \frac{R}{R + G + B}$$

$$g = \frac{G}{R + G + B}$$

Training is used to compute the mean and covariance matrix associated with C. Subsequently, two different segmentation criteria are considered:

Malahanobis distance: This decision rule assumes that the face pixels are Gaussian distributed in the normalized color space. A pixel C under consideration is classified as a face pixel if it lies within an ellipsoid about the computed mean of this distribution, i.e.:

(C−μ_{c})^{t}Σ_{c}⁻¹(C−μ_{C})≦T

where μ_{c} and Σ_{c} are the mean and variance of the training region in the normalized RGB space, and T is a specified threshold.

A faster criterion is based on bounds on the normalized red (r) and green (g) values:

(|r_{i,j}−\overline{r}|≦Tᵣ) [symbol] (|g_{i,j}≦\overline{g}|≦T_{g})

Robust face localization is required to compensate for several factors which may impair the fleshtone detection and the subsequent location of the face, such as

Nature of the light source

Multiple light sources

The presence of specular objects or very bright objects in the scene

Presence of confusers such as other flesh-colored objects

Artifacts in low quality cameras such as “bleeding”

In one embodiment, face localization can be improved by the following methods:

Using robust spatial computations: Even when the fleshtone detection is perfect, the computed face position may be incorrect if the driver's hands are visible, since first and second order moments of all skin-tone pixels in the image are used to compute it. Instead of using the first moment of all the white pixels to locate the center of the face, the median is used to make the center less sensitive to outliers. White pixels lying inside a rectangle centered on the median are used to compute the second moment.

Using robust color measurements: The flesh-tone detector described in the previous section tends to be sensitive to the training window. If this window happens to contain some pixels from the background, the results are usually quite poor. Robust statistics (median and bounded variance) can instead be used to characterize the training region.

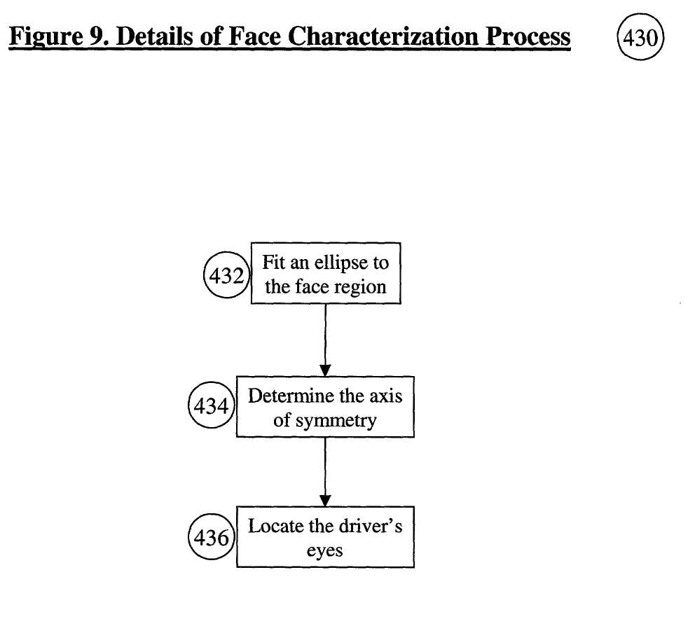

FIG. 9 shows in more detail the face characterization process 430. First, the process fits an ellipse to the face region (step 432). Next, it determines the axis of symmetry (step 434). The process then locates the driver's eyes (step 436).

Once the face is localized, more information about the face can be extracted, such as symmetry, location of facial features. In order to determine if the driver is looking ahead, the lateral symmetry of the face is used to quantify its “frontality”. The assumption is that the camera is positioned such that the driver's face is symmetric when he/she is looking forward. In order to measure symmetry, the axis of symmetry is determined. Thus, if the pixels on the drivers face can be considered to be Gaussian distributed, the major axis of this distribution corresponds to the axis of symmetry.

For measuring the symmetry of the face, various probe positions are formed using a grid aligned with the face axial orientation. On these probe positions (a) the original pixel intensity or (b) the gradient image is averaged and quantized over a local window to form an intensity measurement at that position. The symmetry of the face is evaluated by quantifying how similar the probe pixel values are on either side of this axis. This could be done by using any one of the measures quantifying similarity, ranging from linear distance measures, correlation measures, or information theoretic measures (e.g. mutual information). To avoid problems due to non-uniform illumination on the face, a modified version of Kendall's Tau correlation, which is a non-parametric correlation measure, is used. Kendall's τ does not directly rely on the underlying pixel measurements values but rather on the mutual rank relationship between any combination of measurement pairs in the dataset being considered. Consider a horizontal line on the left of the symmetry axis containing a set of N probes points, and denote this set by L={L_{i,}i=1 . . . N}. Also denote the corresponding set on the right side of the symmetry axis by R={R_{i,}i=1 . . . N}. There are in either set

$$\frac{1}{2} N ( N - 1 )$$

pairs of distinct points. If the rank ordering in a given pair in the L set is the same as that of the corresponding pair in the R set, this pair is counted as concordant. If the ranking is opposite, this is counted as a discordant pair, if a tie exists in L and not in R (or vice versa) this is counted as an extra L pair (or extra R pair). If ties are in both L and R the pair is not counted. Kendall's Tau measure is then defined as:

$$τ = \frac{\# concordant - \# discordant}{\begin{matrix}\sqrt{\# concordant + \# discordant + \# extraL} \\ \sqrt{\# concordant + \# discordant + \# extraR}\end{matrix}}$$

Although this measure provides some robustness to illumination changes, it tends to return high values corresponding to feature-less parts of the face (which result in a lot of ties). In order to give greater weight to symmetry in textured parts of the face (such as eyes and mouth), the following modified measure is used:

$$τ = \frac{\# concordant - \# discordant}{\begin{matrix}\sqrt{\# concordant + \# discordant + \# extraL + \# ties} \\ \sqrt{\# concordant + \# discordant + \# extraR + \# ties}\end{matrix}}$$

The above measure is still a proper correlation measure in that its value is between −1 and +1. But the presence of flat surfaces weigh down the measure towards zero. In this fashion, it becomes closer in behavior to information theoretic measures such as mutual information in that samples that are flat and uninformative yield correlation values close to zero.

To determine the location of the eyes, projections of the gradient magnitude along the principal axes of the face are used. First, the face orientation and oriented bounding box are as explained in the previous sections. The gradient magnitude is computed in real time. Subsequently the edge magnitude is integrated horizontally and vertically along the axis parallel to the previously determined face orientation. The maximum value of the vertical integral function determines the x-coordinate of the nose in the face local coordinate system. Similarly the maximum and second largest value of the horizontal integral function yields the y-coordinate of the eyebrows, with the eyes generally a close second. Sometimes the eyes actually yield the maximum. This situation can be resolved by searching for the largest two values and taking the one with the largest y value to be that of the eyebrow. The x and y values are combined to give the location of the point in the middle of the eyebrows. The position of the eyes is easily inferred from this position and the eyes are warped back to a cardinal position aligned with the image axis, from which the eye and pupil positions can be searched.

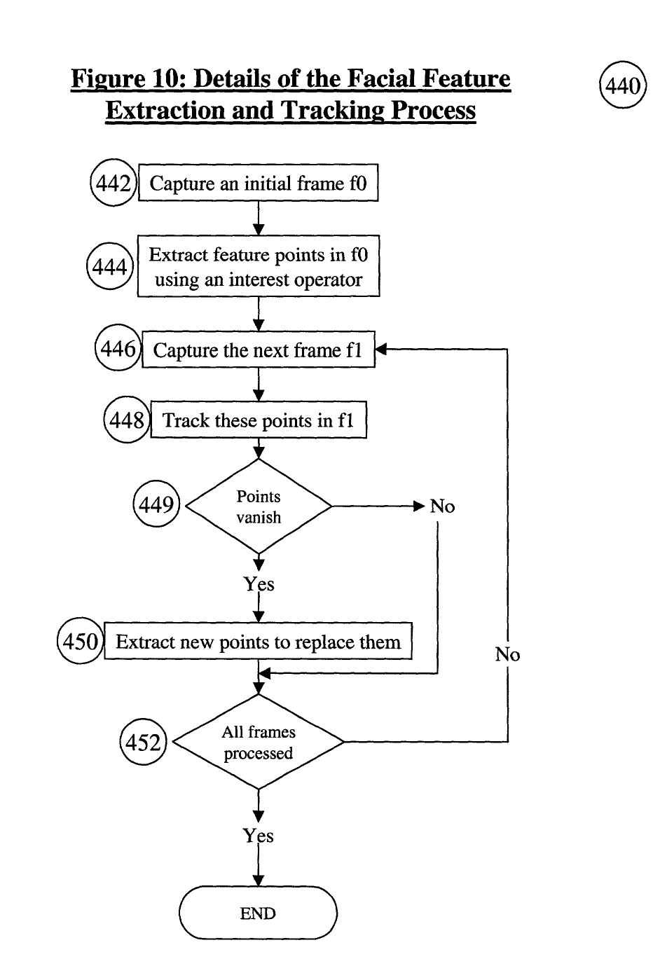

FIG. 10 shows in more detail the process 440 for facial feature extraction and tracking. First, the process captures an initial frame, f0 (step 442). Next, feature points are extracted in the face region in f0 using an interest operator (step 444). The process captures the next frame, f1 (step 446) and tracks these points in f1 (step 448). If points vanish, the process extracts new points to replace them (step 450). The above steps are repeated for each new frame until all frames are processed.

To track head features, a multiresolution approach is used to track good features between successive images. Gradient matrices are computed at each pixel location. Features are detected as singularities of the gradient map by analyzing the eigenvalues of the 2×2 gradient matrices. Features are tracked by minimizing the difference between windows.

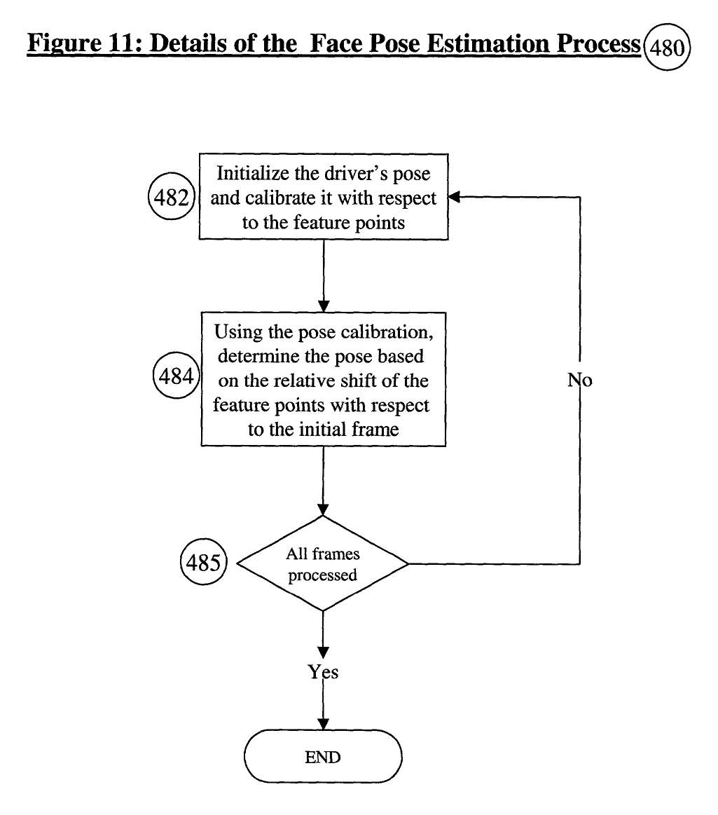

FIG. 11 shows details of the face pose estimation process 480. First, the process initializes the driver's pose and calibrates it with respect to the feature points (step 482). Next, using the pose calibration, the process determines the pose based on the relative shift of the feature points with respect to the initial frame (step 484). These steps are repeated for each frame until all frames are processed.

Pseudo code for processes relating to performing image analysis on a frame of the video is as follows:

Face Detection

From a sample face image, construct color histogram of flesh tone

Capture a background frame of video, fb, withour the driver's face

Capture two frames of video, f1 and f2

Compare f2 with f1 and f2 with fb to detect moving regions and the driver's head

Compare the resulting pixels with the flesh tone histogram to robustly extract the driver's face

Apply image morphology to extract a single connected component for the driver's face

Face Characterization

Fit an ellipse to the face region

Determine the axis of symmetry

Locate the driver's eyes

Facial feature extraction and tracking

Capture an initial frame, f0

Extract feature points in f0 using an interest operator

Capture the next frame, f1

Track these points in f1

If points vanish, extract new points to replace them

Repeat the above for each new frame

Face Pose Estimation

Initialize the driver's pose and calibrate it with respect to the feature points

Using the pose calibration, determine the pose based on the relative shift of the feature points with respect to the initial frame

Repeat the above step for each frame

It will become apparent to those skilled in the art that various modifications to the embodiments of the invention disclosed herein can be made. These and other modifications to the preferred embodiments of the invention as disclosed herein can be made by those skilled in the art without departing from the spirit or scope of the invention as defined by the appended claims.

What is claimed is:

1. A method to process driver glance information from an input video, comprising:
performing motion analysis on the video; and
performing image analysis on a frame of the video.

2. The method of claim 1, further comprising performing temporal analysis.

3. The method of claim 2, further comprising determining the driver glance direction using time-history of motion measurements.

4. The method of claim 2, further comprising segmenting the input video into one or more key frames.

5. The method of claim 1, wherein the motion analysis uses optic flow computation.

6. The method of claim 1, wherein the motion analysis uses feature point tracking.

7. The method of claim 1, wherein the single-frame image analysis uses color and intensity information in the image.

8. The method of claim 1, wherein the single-frame image analysis localizes and characterizes the driver's face.

9. The method of claim 1, further comprising gathering statistics of driver gazing activity.

10. The method of claim 9, wherein each driver gazing activity is summarized with a begin frame, an end frame, nature of the glance, duration of the glance and direction of the glance.

11. The method of claim 1, wherein the motion analysis detects head motion measurement from the video.

12. The method of claim 1, further comprising performing glance recognition from the video

13. The method of claim 12, further comprising detecting qualitative head movements and eye glances.

14. The method of claim 13, wherein the head movements include “looking left”, “looking right”, “looking up”, “looking down” and “looking straight” movements, and eye glances include “left shoulder”, “front”, “rear-view mirror” glances.

15. The method of claim 1, further comprising detecting and characterizing a face and determining its pose from an image of the video.

16. The method of claim 15, further comprising detecting facial symmetry and finding eye positions

17. The method of claim 15, further comprising tracking facial features and determining face pose.

18. The method of claim 1, further comprising performing motion-based video segmentation.

19. The method of claim 1, further comprising performing key frame detection.

20. The method of claim 1, further comprising performing interpreting driver head movements from feature point trajectories in the video.
